(19) United States
(12) Patent Application Publication
(10) Pub. No.: US 2026/0360798 A1
(43) Pub. Date: Nov. 12, 2026

(54) SECONDARY BATTERY, AND METHOD AND APPARATUS FOR MANUFACTURING SAME

(71) Applicant: Samsung SDI Co., Ltd., Yongin-si (KR)

(72) Inventors: Dong Hyun Kim, Suwon-si (KR); Ye Jin Seo, Suwon-si (KR); Eun Jeong Moon, Suwon-si (KR)

(73) Assignee: Samsung SDI Co., Ltd., Yongin-si (KR)

(21) Appl. No.: 19/653,042

(22) Filed: Apr. 20, 2026

(30) Foreign Application Priority Data
May 7, 2025 (KR) 10-2025-0059234

(51) Int. Cl. H01M 10/04; H01M 10/0525; H01M 50/105; H01M 50/178; H01M 50/533

(52) U.S. Cl. CPC H01M 10/0409; H01M 10/0525; H01M 50/105; H01M 50/178; H01M 50/533

(57) ABSTRACT

A secondary battery manufacturing apparatus manufactures a secondary battery having increased internal space efficiency. The secondary battery manufacturing apparatus includes a roller configured to bend a portion of a lead tab electrically connected to a substrate tab bundle extending from an electrode assembly to form a softened bending region, and a pusher configured to bend the bending region.

### CROSS-REFERENCE TO RELATED APPLICATION

This present application claims priority to and the benefit under 35 U.S.C. § 119(a)-(d) of Korean Patent Application No. 10-2025-0059234, filed on May 7, 2025, in the Korean Intellectual Property Office, the entire disclosure of which is incorporated herein by reference.

### BACKGROUND

### Field

The present disclosure relates to a secondary battery manufacturing apparatus, a secondary battery manufacturing method, and a secondary battery.

### Description of the Related Art

In general, with the recent proliferation of electronic devices using batteries, such as mobile phones, notebook computers, and electric vehicles, the demand for secondary batteries having high energy density and high capacity has rapidly increased. Accordingly, research and development to improve the performance of lithium secondary batteries are being actively conducted.

The lithium secondary batteries are batteries including a positive electrode and a negative electrode, each of which includes an active material capable of intercalation and deintercalation of lithium ions, and an electrolyte, and generate electric energy through an oxidation-reduction reaction occurring when lithium ions are intercalated/deintercalated into/from the positive electrode and the negative electrode.

The herein-described information disclosed in the background technology of the present disclosure is merely intended to improve understanding of the background of the present disclosure and thus may include information that does not form the related art.

### SUMMARY

According to embodiments of the present disclosure, there is provided a secondary battery manufacturing apparatus including a roller configured to bend a portion of a lead tab electrically connected to a substrate tab bundle extending from an electrode assembly to form a softened bending region, and a pusher configured to bend the bending region.

The secondary battery manufacturing apparatus may further include a jig configured to move toward an upper side of the lead tab and support the lead tab at the upper side, and the roller may perform primary bending of the lead tab along the jig.

The pusher may move toward a lower side of the lead tab to support the lead tab at the lower side, and the roller may perform secondary bending of the lead tab, on which the primary bending has been performed, along the pusher to form the bending region.

The primary bending and the secondary bending may be performed in different directions from one another.

The pusher may move in a first direction toward the lead tab from the lower side of the lead tab to bend the substrate tab bundle.

The pusher may move in a second direction toward the electrode assembly and bend the bending region to form a bent portion.

The secondary battery manufacturing apparatus may further include a guide configured to move toward an upper side of the substrate tab bundle and guide the substrate tab bundle.

The roller may press the lead tab at a pressure of 0.2 MPa or more and 0.6 MPa or less to form the bending region.

The secondary battery manufacturing apparatus may further include a sensor configured to detect a position of the bending region.

The pusher may bend the bending region so that the lead tab is bent at an angle of 100° or less.

According to embodiments of the present disclosure, there is provided a secondary battery manufacturing method including bending a portion of a lead tab electrically connected to a substrate tab bundle extending from an electrode assembly to form a softened bending region, and bending the bending region.

The secondary battery manufacturing method may further include supporting, by a jig, the lead tab at an upper side of the lead tab, and performing primary bending of the lead tab.

The secondary battery manufacturing method may further include supporting, by a pusher, the lead tab at a lower side thereof, and performing secondary bending of the lead tab, on which the primary bending has been performed, to form the bending region, and the primary bending and the secondary bending may be performed in different directions from one another.

The secondary battery manufacturing method may further include moving the pusher in a first direction toward the lead tab from the lower side of the lead tab to bend the substrate tab bundle, and moving the pusher in a second direction toward the electrode assembly and bending the bending region to form a bent portion.

The pusher may cause the bent portion to be bent at an angle of 100° or less.

According to embodiments of the present disclosure, there is provided a secondary battery including an electrode assembly from which a substrate tab bundle extends, a case accommodating the electrode assembly, and a lead tab of which one side is electrically connected to the substrate tab bundle and another side is led out of the case, wherein the lead tab includes a bent portion formed by bending a softened bending region.

The lead tab may include a first region, and a second region including the bent portion and formed to have a smaller thickness than a thickness of the first region.

The bent portion may be bent at an angle of less than or equal to 100°.

The bent portion may be located inside the case.

The secondary battery may further include an insulating member surrounding the lead tab and located between the lead tab and the case, and the bent portion may be located so as not to overlap the insulating member.

### BRIEF DESCRIPTION OF THE DRAWINGS

The following drawings appended to the present specification are intended to illustrate exemplary embodiments of the present disclosure, and the spirit of the present disclosure will be more clearly understood from the accompanying drawings together with the following description of the disclosure, and thus illustrations in the drawings should not be construed as limiting the scope of the present disclosure, in which:

FIG. 1 is a perspective view schematically illustrating an example of a secondary battery according to embodiments of the present disclosure;

FIG. 2 is a perspective view schematically illustrating another example of the secondary battery according to embodiments of the present disclosure;

FIG. 3 is a view schematically illustrating an electrode according to embodiments of the present disclosure;

FIG. 4 is a flowchart illustrating a secondary battery manufacturing method according to embodiments of the present disclosure;

FIG. 5 is a view illustrating a process of manufacturing a secondary battery using a secondary battery manufacturing apparatus according to embodiments of the present disclosure;

FIG. 6 is a view illustrating a process of manufacturing a secondary battery using the secondary battery manufacturing apparatus according to embodiments of the present disclosure;

FIG. 7 is a view illustrating a process of manufacturing a secondary battery using the secondary battery manufacturing apparatus according to embodiments of the present disclosure;

FIG. 8 is a view illustrating a process of manufacturing a secondary battery using the secondary battery manufacturing apparatus according to embodiments of the present disclosure;

FIG. 9 is a view illustrating a process of manufacturing a secondary battery using the secondary battery manufacturing apparatus according to embodiments of the present disclosure;

FIG. 10 is a view illustrating a secondary battery manufactured by the secondary battery manufacturing apparatus according to embodiments of the present disclosure;

FIG. 11 is a photograph illustrating a conventional secondary battery; and

FIG. 12 is a photograph illustrating a secondary battery according to embodiments of the present disclosure.

### DETAILED DESCRIPTION

Hereinafter, exemplary embodiments of the present disclosure will be described in detail with reference to the accompanying drawings. Prior to this, the terms or words used in the present specification and claims should not be construed as being limited to ordinary or dictionary meanings and should be construed as meanings and concepts consistent with the technical spirit of the present disclosure based on the principle that an inventor can appropriately define concepts and terms to explain the disclosure of the inventor in the best way. Therefore, the embodiments described herein and the configuration illustrated in the drawings are only the most preferred some embodiments and are not representative of the full technical spirit of the present disclosure, and thus, it should be understood that various equivalents and modifications may be made at the time of filing the present application.

Further, when used in the present specification, “comprise/include” and/or “comprising/including” may specify the presence of stated shapes, numbers, steps, operations, members, elements, and/or groups thereof and may not exclude the presence or addition of one or more other shapes, numbers, steps, operations, members, elements, and/or groups thereof.

Further, to help understanding of the disclosure, the accompanying drawings may not be drawn to actual scale. Rather, sizes of some components may be exaggerated. In addition, the same reference numerals may be assigned to the same components in different embodiments.

When it is stated that two objects being compared are “the same,” this may mean that they are “substantially the same.” Thus, the range of the expression “substantially the same” may include a case of having a deviation considered as a low degree, for example, a deviation within 5%. In addition, the description that a certain parameter is the same in a certain region may denote that the parameter is uniform from an average perspective.

Terms including ordinals such as first and second may be used to describe various components, but, of course, the components are not limited by the terms. These terms are merely used to distinguish one component from another. Unless particularly described as the opposite, a first component may also be a second component.

Throughout the specification, unless particularly described otherwise, each component may be provided in singular or plural form.

The arrangement of any configuration on an “upper portion (or lower portion)” of a component or “on (or below)” the component may mean not only any configuration may be disposed to be in contact with an upper surface (or lower surface) of the component but also that another configuration may be interposed between the component and any configuration disposed on (or below) the component.

In addition, when it is described that a component is “disposed on,” “connected to,” or “coupled to” another component, these components may be directly connected or coupled to one another, but it should be understood that still another component may be “interposed” between these components, or these components are “connected”, “coupled” or “accessed” through still another component.

As used herein, the term “and/or” includes any and all combinations of one or more of the associated listed items. Further, when describing embodiments of the present disclosure, the use of “may” means one or more embodiments of the present disclosure. When preceding a list of elements, the terms “one or more” and “at least one” modify the entire list of elements and do not modify the individual elements of the list.

The expression “A and/or B” throughout the specification means A, B, or A and B, unless otherwise differently stated. The expression “C to D” means greater than or equal to C and less than or equal to D, unless otherwise specified.

When phrases such as “at least one of A, B and C,” “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C.

As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, and the like may be used herein to describe various elements, components, regions, layers, and/or sections, these elements, components, regions, layers, and/or sections should not be limited by these terms. These terms are used to distinguish one element, component, region, drawing layer, or cross section from another element, component, region, drawing layer, or cross section. Thus, a first element, component, region, layer, or section discussed herein could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the drawings. It will be understood that the spatially relative terms are intended to encompass different orientations of the device in use or operation in addition to the orientation depicted in the figures. For example, when the device in the drawing is turned over, elements described as “below” or “beneath” other elements would then be oriented “above” or “over” the other elements. Thus, the term “below” may encompass both an orientation of above and below.

The terms used in the present specification are intended to describe embodiments of the present disclosure and are not intended to limit the present disclosure.

The present disclosure provides a secondary battery manufacturing apparatus capable of reducing a bending angle of a lead tab, a secondary battery manufacturing method, and a secondary battery in which the bending angle of the lead tab is reduced.

However, the problems to be solved by the present disclosure are not limited to the herein-mentioned problem, and other problems that are not mentioned can be clearly understood by those skilled in the art from the following description.

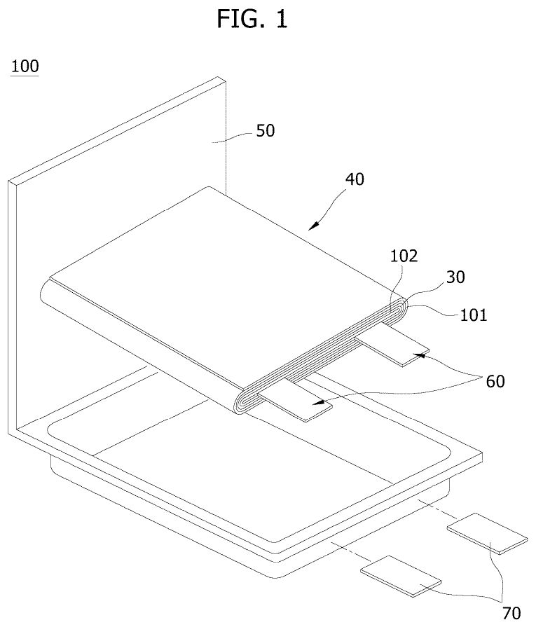

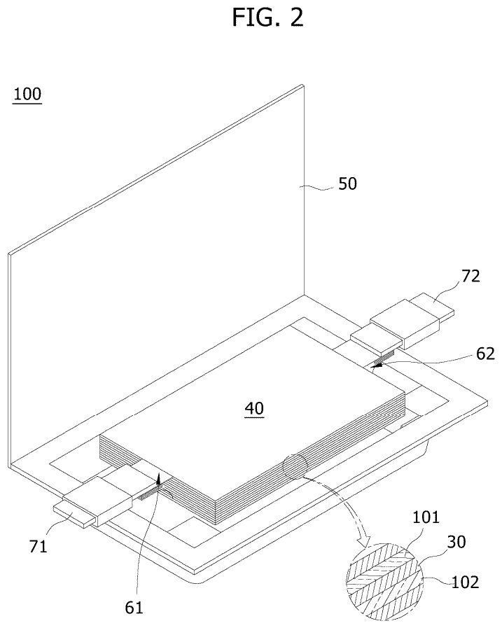

FIG. 1 is a perspective view schematically illustrating an example of a secondary battery according to embodiments of the present disclosure. FIG. 2 is a perspective view schematically illustrating another example of the secondary battery according to embodiments of the present disclosure. Referring to FIGS. 1 and 2, a secondary battery 100 may include an electrode assembly 40 and a case 50.

The case 50 may form a schematic exterior of the secondary battery 100 and may accommodate the electrode assembly 40 therein.

The electrode assembly 40 may function as a unit structure that performs charging and discharging operations of power in the secondary battery 100. The electrode assembly 40 may be accommodated in the case 50.

The electrode assembly 40 includes a first electrode 101 and a second electrode 102. The first electrode 101 is a positive electrode or a negative electrode. The second electrode 102 is a negative electrode or a positive electrode and has a different polarity from the first electrode 101. Hereinafter, a case in which the first electrode 101 is a positive electrode and the second electrode 102 is a negative electrode may be described as an example.

The electrode assembly 40 may further include a separator 30 located between the first electrode 101 and the second electrode 102. The separator 30 may prevent the first electrode 101 from being in contact with the second electrode 102 and may prevent the occurrence of a short circuit between the first electrode 101 and the second electrode 102. The electrode assembly 40 may be formed by stacking the first electrode 101, the second electrode 102, and the separator 30 provided between the first electrode 101 and the second electrode 102.

A detailed description of each component of the electrode assembly 40 is provided herein.

### Positive Electrode Active Material

As a positive electrode active material, a compound (a lithiated intercalation compound) capable of reversible intercalation and deintercalation of lithium may be used. Specifically, one or more composite oxides of lithium and a metal selected from cobalt, manganese, nickel, and combinations thereof may be used.

The composite oxide may be a lithium-transition metal composite oxide, and specific examples thereof may include lithium nickel-based oxide, lithium cobalt-based oxide, lithium manganese-based oxide, lithium iron phosphate-based compound, cobalt-free nickel-manganese-based oxide, or a combination thereof.

As an example, compounds represented by any one of the following chemical formulas may be used: LiₐA_{1-b}X_{b}O_{2-c}D_{c}(0.90≤a≤1.8, 0≤b≤0.5, 0≤c≤0.05); LiₐMn_{2-b}X_{b}O_{4-c}D_{c}(0.90≤a≤1.8, 0≤b≤0.5, 0≤c≤0.05); LiₐNi_{1-b}-cCo_{b}XcO_{2-α}Dα(0.90≤a≤1.8, 0≤b>0.5, 0≤c≤0.5, 0≤α≤2); LiₐNi_{1-b}-cMn_{b}XcO₂-αDα(0.90≤a≤1.8, 0≤b≤0.5, 0≤c≤0.5, 0<α<2); LiₐNi_{b}CocL₁dGeO₂(0.90≤a≤1.8, 0≤b≤0.9, 0≤c≤0.5, 0≤d≤0.5, 0≤e≤0.1); LiₐNiG_{b}O₂(0.90≤a≤1.8, 0.001≤b≤0.1); LiₐCoG_{b}O₂(0.90≤a≤1.8, 0.001≤b≤0.1); LiₐMn_{1-b}GbO₂(0.90≤a≤1.8, 0.001≤b≤0.1); LiₐMn₂GbO₄(0.90≤a≤1.8, 0.001≤b≤0.1); LiₐMn₁-gGgPO₄(0.90≤a≤1.8, 0≤g≤0.5); Li(₃-ƒ) Fe₂( P [symbol] Ni, Co, Mn, or a combination thereof; X is Al, Ni, Co, Mn, Cr, Fe, Mg, Sr, V, a rare-earth element or a combination thereof; D is O, F, S, P, or a combination thereof; G is Al, Cr, Mn, Fe, Mg, La, Ce, Sr, V, or a combination thereof; and L1 is Mn, Al, or a combination thereof.

As an example, the positive electrode active material may be a high-nickel-based positive electrode active material having a nickel content of greater than or equal to 80 mol %, greater than or equal to 85 mol %, greater than or equal to 90 mol %, greater than or equal to 91 mol %, or greater than or equal to 94 mol % and less than or equal to 99 mol % based on 100 mol % of the metal excluding lithium in the lithium-transition metal composite oxide. The high-nickel-based positive electrode active material may be capable of realizing high capacity and can be applied to high-capacity and high-density lithium batteries.

### Positive Electrode

A positive electrode for the secondary battery 100 may include a positive electrode substrate and a positive electrode mixture layer formed on the positive electrode substrate. The positive electrode mixture layer includes a positive electrode active material and may further include a binder and/or a conductive material.

As an example, the positive electrode may further include an additive capable of serving as a sacrificial positive electrode.

The positive electrode active material may be included in an amount of 90 wt% to 99.5 wt % based on 100 wt % of the positive electrode mixture layer, and the binder and the conductive material may each be included in an amount of 0.5 wt % to 5 wt % based on 100 wt % of the positive electrode mixture layer.

The binder serves to adhere positive electrode active material particles well to one another and also to adhere the positive electrode active material to the positive electrode substrate well. Representative examples of the binder include polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, styrene-butadiene rubber, (meth)acrylated styrene-butadiene rubber, an epoxy resin, a (meth)acrylic resin, a polyester resin, nylon, or the like, but the present disclosure is not limited thereto.

The conductive material is used to provide conductivity to the electrode, and any material that does not cause a chemical change and is electrically conductive may be used in the configured battery. Examples of the conductive material may include a carbon-based material such as natural graphite, artificial graphite, carbon black, acetylene black, Ketjen black, carbon fibers, carbon nanofibers, or carbon nanotubes; a metal-based material in the form of a metal powder or metal fiber including copper, nickel, aluminum, silver, and the like; a conductive polymer such as a polyphenylene derivative; or a mixture thereof.

Al may be used as the positive electrode substrate, but the present disclosure is not limited thereto.

### Negative Electrode Active Material

The negative electrode active material includes a material that can reversibly intercalate/deintercalate lithium ions, a lithium metal, a lithium metal alloy, a material capable of being doped with and dedoped from lithium, or a transition metal oxide.

Examples of the material capable of reversibly intercalating and deintercalating lithium ions may include a carbon-based negative electrode active material including, for example, crystalline carbon, amorphous carbon, or a combination thereof. Examples of the crystalline carbon may include graphite such as amorphous, plate-shaped, flake-shaped, spherical, or fibrous natural graphite or artificial graphite. Examples of the amorphous carbon may include soft carbon or hard carbon, mesophase pitch carbide, calcined coke, and the like.

The lithium metal alloy may be an alloy of lithium and a metal selected from Na, K, Rb, Cs, Fr, Be, Mg, Ca, Sr, Si, Sb, Pb, In, Zn, Ba, Ra, Ge, Al, and Sn.

A Si-based negative electrode active material or a Sn-based negative electrode active material may be used as the material capable of being doped with and dedoped from lithium. The Si-based negative electrode active material may include silicon, a silicon-carbon composite, SiOₓ (0<x<2), a Si—Q alloy (where Q is selected from an alkali metal, an alkaline-earth metal, a Group 13 element, a Group 14 element (excluding Si), a Group 15 element, a Group 16 element, a transition metal, a rare-earth element, and a combination thereof), or a combination thereof. The Sn-based negative electrode active material may be Sn, SnO2, a Sn-based alloy, or a combination thereof.

The silicon-carbon composite may be a composite of silicon and amorphous carbon. According to embodiments, the silicon-carbon composite may be in the form of silicon particles and amorphous carbon applied on the surface of the silicon particles. For example, the silicon-carbon composite may include a secondary particle (core) in which silicon primary particles are agglomerated and an amorphous carbon coating layer (shell) located on the surface of the secondary particle. The amorphous carbon may also be located between the silicon primary particles, such that, for example, the silicon primary particles are coated with amorphous carbon. The secondary particles may be dispersed in an amorphous carbon matrix.

The silicon-carbon composite may further include crystalline carbon. For example, the silicon-carbon composite may include a core including crystalline carbon and silicon particles and an amorphous carbon coating layer located on the surface of the core.

The Si-based negative electrode active material or the Sn-based negative electrode active material may be used by being mixed with a carbon-based negative electrode active material.

Negative electrode

A negative electrode for the secondary battery 100 includes a negative electrode substrate and a negative electrode mixture layer located on the negative electrode substrate. The negative electrode mixture layer includes a negative electrode active material and may further include a binder and/or a conductive material.

For example, the negative electrode mixture layer may include 90 wt % to 99 wt % of the negative electrode active material, 0.5 wt % to 5 wt % of the binder, and 0 wt % to 5 wt % of the conductive material.

The binder serves to adhere negative electrode active material particles well to one another and also to adhere the negative electrode active material to the negative electrode substrate well. A non-aqueous binder, an aqueous binder, a dry binder, or a combination thereof may be used as the binder.

The non-aqueous binder may include polyvinylchloride, carboxylated polyvinylchloride, polyvinylfluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous binder may be selected from styrene-butadiene rubber, (meth)acrylated styrene-butadiene rubber, (meth)acrylonitrile-butadiene rubber, (meth)acrylic rubber, butyl rubber, fluororubber, a polyethylene oxide, polyvinylpyrrolidone, polyepichlorohydrin, polyphosphazene, poly(meth)acrylonitrile, an ethylene propylene diene copolymer, polyvinylpyridine, chlorosulfonated polyethylene, latex, a polyester resin, a (meth)acrylic resin, a phenolic resin, an epoxy resin, polyvinyl alcohol, and a combination thereof.

When the aqueous binder is used as the negative electrode binder, a cellulose-based compound capable of imparting viscosity may be further included. As the cellulose-based compound, one or more of carboxymethyl cellulose, hydroxypropylmethyl cellulose, methyl cellulose, or alkali metal salts thereof may be used in combination. Na, K, or Li may be used as the alkali metal.

The dry binder is a polymer material capable of being fiberized, and may be, for example, polytetrafluoroethylene, polyvinylidene fluoride, a polyvinylidene fluoride-hexafluoropropylene copolymer, a polyethylene oxide, or a combination thereof.

The conductive material is used to provide conductivity to the electrode, and any material that does not cause a chemical change and is electrically conductive may be used in the configured battery. Specific examples of the conductive material may include a carbon-based material such as natural graphite, artificial graphite, carbon black, acetylene black, Ketjen black, carbon fibers, carbon nanofibers, or carbon nanotubes; a metal-based material in the form of a metal powder or metal fiber including copper, nickel, aluminum, silver, and the like; a conductive polymer such as a polyphenylene derivative; or a mixture thereof.

The negative electrode substrate may be selected from a copper foil, a nickel foil, a stainless steel foil, a titanium foil, a nickel foam, a copper foam, a polymer substrate coated with a conductive metal, and a combination thereof.

### Separator 30

The separator 30 may be present between the first electrode 101 and the second electrode 102 depending on a type of the secondary battery 100. The separator may be made of polyethylene, polypropylene, polyvinylidene fluoride, or a multilayer film of two or more layers thereof, and may, of course, also be made of a mixed multilayer film, such as a polyethylene/polypropylene double-layered separator, a polyethylene/polypropylene/polyethylene three-layered separator, and a polypropylene/polyethylene/polypropylene three-layered separator. The separator 30 may include a porous substrate, and a coating layer including an organic material, an inorganic material, or a combination thereof located on one surface or both surfaces of the porous substrate.

The porous substrate may be a polymer film formed of a polymer, or a copolymer or a mixture of two or more selected from polyolefins such as polyethylene, polypropylene, and the like, polyesters such as polyethylene terephthalate, polybutylene terephthalate, and the like, polyacetal, polyamide, polyimide, polycarbonate, polyetheretherketone, polyaryletherketone, polyetherimide, polyamideimide, polybenzimidazole, polyether sulfone, a polyphenylene oxide, a cyclic olefin copolymer, polyphenylene sulfide, polyethylene naphthalate, glass fibers, Teflon, and polytetrafluoroethylene.

The organic material may include a polyvinylidene fluoride-based polymer or a (meth)acrylic-based polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof, but the present disclosure is not limited thereto.

The organic and inorganic materials may be present by being mixed in one coating layer or may be present in a form in which a coating layer including organic materials and a coating layer including inorganic materials are stacked.

### Electrolyte

The electrolyte for the secondary battery 100 includes a non-aqueous organic solvent and a lithium salt.

The non-aqueous organic solvent serves as a medium through which ions involved in an electrochemical reaction of the battery can move.

The non-aqueous organic solvent may be a carbonate-based solvent, an ester-based solvent, an ether-based solvent, a ketone-based solvent, an alcohol-based solvent, an aprotic solvent, or a combination thereof.

The carbonate-based solvent may include dimethyl carbonate (DMC), diethyl carbonate (DEC), dipropyl carbonate (DPC), methylpropyl carbonate (MPC), ethylpropyl carbonate (EPC), methyl ethyl carbonate (MEC), ethylene carbonate (EC), propylene carbonate (PC), butylene carbonate (BC), and the like.

The ester-based solvent may include methyl acetate, ethyl acetate, n-propyl acetate, dimethyl acetate, methyl propionate, ethyl propionate, decanolide, mevalonolactone, valerolactone, caprolactone, and the like.

The ether-based solvent may include dibutyl ether, tetraglyme, diglyme, dimethoxyethane, 2-methyltetrahydrofuran, 2,5-dimethyltetrahydrofuran, tetrahydrofuran, and the like. In addition, the ketone-based solvent may include cyclohexanone and the like. The alcohol-based solvent may include ethyl alcohol, isopropyl alcohol, and the like, and the aprotic solvent may include nitriles such as R—CN (where R is a C2 to C20 linear, branched, or cyclic hydrocarbon group and includes a double bond, an aromatic ring, or an ether bond), and the like; amides such as dimethyl formamide; dioxolanes such as 1,3-dioxolane and 1,4-dioxolane; sulfolanes; and the like.

The non-aqueous organic solvents may be used alone or in combination with two or more thereof.

In addition, when the carbonate-based solvent is used, a cyclic carbonate and a chain carbonate may be mixed and used, and the cyclic carbonate and the chain carbonate may be mixed in a volume ratio of 1:1 to 1:9.

The lithium salt is a material that is dissolved in the organic solvent and serves as a source of lithium ions in a battery, enables basic operation of a lithium battery, and promotes the movement of lithium ions between positive and negative electrodes. Representative examples of the lithium salt may include one or two or more selected from LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide, LiFSI), LiC₄F₉SO₃, LiN(CₓF₂ₓ₊₁SO₂)(C_{γ}F_{2γ+1}SO₂) (where x and y are integers of 1 to 20), lithium trifluoromethane sulfonate, lithium tetrafluoroethanesulfonate, lithium difluorobis(oxalato)phosphate (LiDFOB), and lithium bis(oxalato) borate (LiBOB).

As shown in FIG. 1, the electrode assembly 40 may be formed in a stack form in which the first electrode 101, the second electrode 102, and the separator 30 are stacked. Alternatively, as shown in FIG. 2, the electrode assembly 40 may be formed in a wound form in which the first electrode 101, the separator 30 located between the first electrode 101 and the second electrode 102, and the second electrode 102 are stacked and wound.

The case 50 may accommodate the electrode assembly 40. The case 50 may seal both the electrode assembly 40 and an electrolyte.

The case 50 may be formed of a flexible exterior material such as a pouch. The case 50 may include insulating layers (not shown) formed on both surfaces of a thin metal layer (not shown), such as an aluminum layer, and may be formed through a forming process such as drawing.

Tabs 70 may extend from the electrode assembly 40. The tabs 70 may be connected to the electrode assembly 40 and may extend to the outside of the case 50.

The tabs 70 may include a first tab 71 and a second tab 72. The first tab 71 and the second tab 72 may extend in the same direction from one side of the electrode assembly 40. Alternatively, as shown in FIG. 2, the first tab 71 and the second tab 72 may extend in opposite directions from both sides of the electrode assembly 40.

The first tab 71 may be electrically connected to the first electrode 101. The first tab 71 may be formed by extending a substrate of the first electrode 101. For example, the first tab 71 may be formed by extending the positive electrode substrate. Alternatively, one side of the first tab 71 may be bonded to the substrate of the first electrode 101, and the other side of the first tab 71 may extend from the substrate of the first electrode 101. For example, one side of the first tab 71 may be bonded to the positive electrode substrate, and the other side of the first tab 71 may extend from the positive electrode substrate.

The second tab 72 may be electrically connected to the second electrode 102. The second tab 72 may be formed by extending a substrate of the second electrode 102. For example, the second tab 72 may be formed by extending the negative electrode substrate. Alternatively, one side of the second tab 72 may be bonded to the substrate of the second electrode 102, and the other side of the second tab 72 may extend from the substrate of the second electrode 102. For example, one side of the second tab 72 may be bonded to the negative electrode substrate, and the other side of the second tab 72 may extend from the negative electrode substrate.

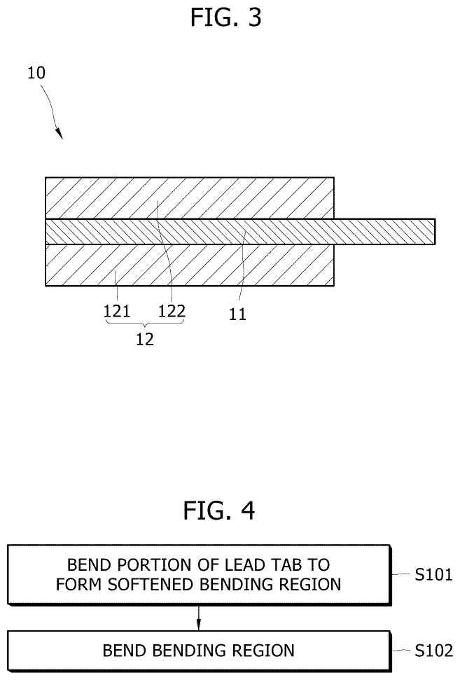

FIG. 3 is a view schematically illustrating an electrode according to embodiments of the present disclosure.

As described herein, the electrode assembly 40 may include the first electrode 101, the second electrode 102, and the separator 30 located between the first electrode 101 and the second electrode 102. In FIG. 3, reference numeral 10 denotes an electrode according to embodiments of the present disclosure. The electrode 10 may include at least one of the first electrode 101 and the second electrode 102. Accordingly, the description of the electrode 10 may be equally or similarly applied to the first electrode 101 and/or the second electrode 102.

The electrode 10 may include a substrate 11. In addition, the electrode 10 may further include a mixture layer 12.

The substrate 11 may perform the same or similar role as the positive electrode substrate and/or the negative electrode substrate described with reference to FIGS. 1 and 2. The substrate 11 may allow current to flow through the electrode 10. For example, the substrate 11 may perform a conductive function and/or current collecting function. For example, the substrate 11 may provide a path through which electrons can move to the mixture layer 12.

For example, the substrate 11 may include a conductive material. For example, the conductive material may include a metal material, a carbon-based material, a combination thereof, and the like.

For example, the metal material may include silver (Ag), copper (Cu), gold (Au), aluminum (Al), tungsten (W), zinc (Zn), nickel (Ni), iron (Fe), platinum (Pt), tin (Sn), an alloy including at least two thereof, and the like.

For example, the carbon-based material may include graphite, carbon nanotubes, graphene, and the like.

For example, when the electrode 10 corresponds to a positive electrode, the substrate 11 may include aluminum. For example, when the electrode 10 corresponds to a negative electrode, the substrate 11 may include copper.

As described with reference to FIGS. 1 and 2, the mixture layer 12 includes an active material. The mixture layer 12 may further include a conductive material, a binder, and the like. As shown in FIG. 3, the mixture layer 12 may be formed on both surfaces of the substrate 11. For example, the mixture layer 12 may include a first mixture layer 121 provided on a portion of one surface of the substrate 11 and a second mixture layer 122 provided on a portion of the other surface of the substrate 11. In this case, the first mixture layer 121 and the second mixture layer 122 may be symmetrically located with respect to the substrate 11. Alternatively, the first mixture layer 121 and the second mixture layer 122 may be formed asymmetrically with respect to the substrate 11 and may be formed to have different areas. However, unlike that shown in FIG. 3, the mixture layer 12 may be formed only on one surface of the substrate 11. Hereinafter, a case in which the mixture layer 12 is provided on both surfaces of the substrate 11 will be described as an example.

The mixture layer 12 may be formed in a slurry state and may be formed by being applied on the substrate 11. Alternatively, the mixture layer 12 may be formed in a free-standing film state and may be formed by being attached onto the substrate 11.

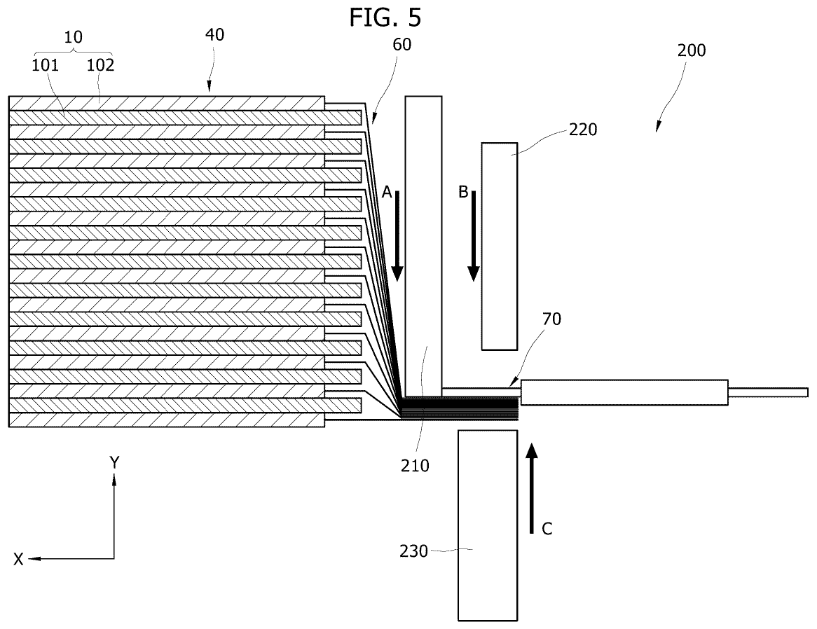

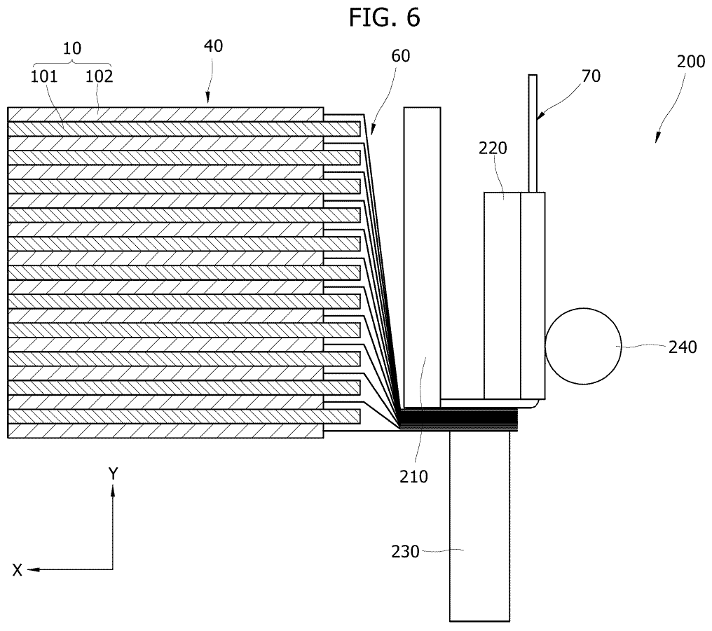

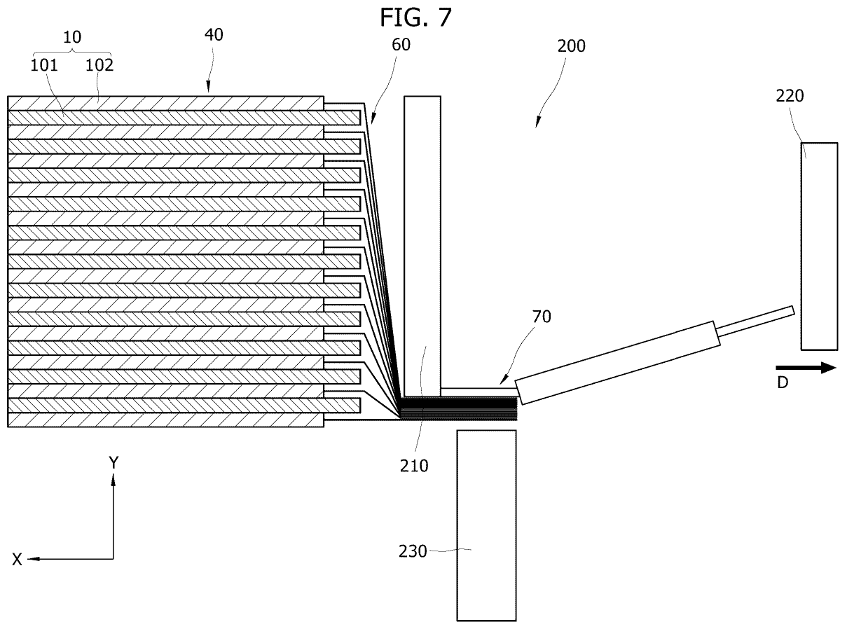

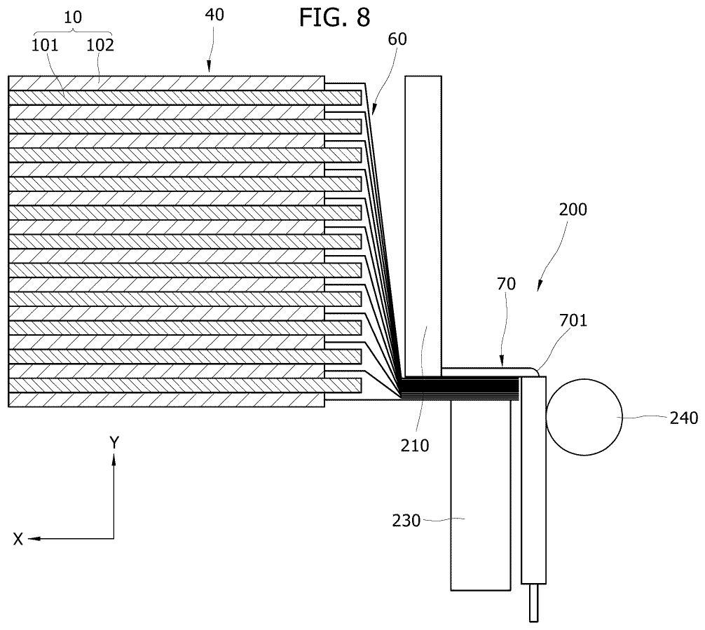

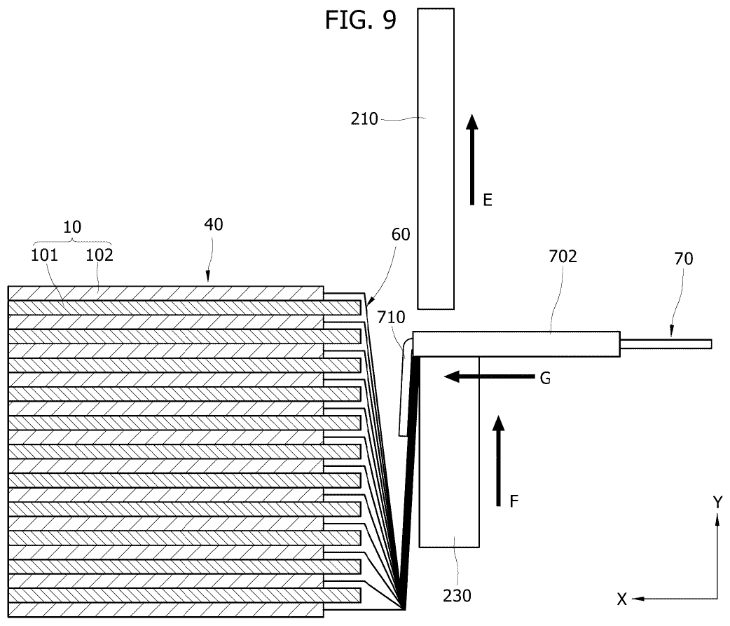

Accordingly, the substrate 11 may have a region in which the mixture layer 12 is not provided and is exposed to the outside. For example, one side of the substrate 11 may be exposed to the outside, and the mixture layer 12 may be provided on the other side of the substrate 11. The exposed region of the substrate 11 may provide a space capable of being electrically connected to the outside. For example, the exposed region of the substrate 11 may serve as a substrate tab. FIG. 4 is a flowchart illustrating a secondary battery manufacturing method according to embodiments of the present disclosure. FIG. 5 is a view illustrating a process of manufacturing a secondary battery using a secondary battery manufacturing apparatus according to embodiments of the present disclosure. FIG. 6 is a view illustrating a process of manufacturing a secondary battery using the secondary battery manufacturing apparatus according to embodiments of the present disclosure. FIG. 7 is a view illustrating a process of manufacturing a secondary battery using the secondary battery manufacturing apparatus according to embodiments of the present disclosure. FIG. 8 is a view illustrating a process of manufacturing a secondary battery using the secondary battery manufacturing apparatus according to embodiments of the present disclosure. FIG. 9 is a view illustrating a process of manufacturing a secondary battery using the secondary battery manufacturing apparatus according to embodiments of the present disclosure.

In FIGS. 5 to 9, an X-axis may indicate a direction in which a substrate tab bundle 60 extends from an electrode assembly 40. In FIGS. 5 to 9, a Y-axis may indicate a direction in which a plurality of electrodes 10 are stacked in the electrode assembly 40. The X-axis and the Y-axis may indicate directions perpendicular to one another.

As described herein, a secondary battery 100 (for example, including the secondary battery 100 described with reference to FIGS. 1 to 3) includes the electrode assembly 40, the substrate tab bundle 60 extending from the electrode assembly 40, and a lead tab 70 electrically connected to the substrate tab bundle 60. In this case, the substrate tab bundle 60 may be formed by extending the substrate 11 described with reference to FIG. 3. The substrate tab bundle 60 may be a bundle formed by stacking a plurality of substrates 11. In FIGS. 5 to 10, the substrate tab bundle 60 formed by extending the substrate 11 of one of a first electrode 101 and a second electrode 102 is illustrated.

FIGS. 4 to 9 illustrate a manufacturing method and/or a manufacturing apparatus for manufacturing the secondary battery 100. Hereinafter, a method of manufacturing the secondary battery 100 using a secondary battery manufacturing method and/or a secondary battery manufacturing apparatus 200 will be described in detail.

The secondary battery manufacturing method according to embodiments of the present disclosure includes bending a portion of the lead tab 70 to form a softened bending region 701 (S101). In addition, the secondary battery manufacturing method according to embodiments of the present disclosure includes bending the bending region 701 to form a bent portion 710 (S102). To this end, the secondary battery manufacturing apparatus 200 according to embodiments of the present disclosure includes a roller 240 and a pusher 230. The secondary battery manufacturing apparatus 200 may further include a guide 210. The secondary battery manufacturing apparatus 200 may further include a jig 220. The secondary battery manufacturing apparatus 200 may include all or some of components illustrated in FIGS. 5 to 9 and may further include components not illustrated in FIGS. 5 to 9.

As shown in FIG. 5, one side of the substrate tab bundle 60 extending from the electrode assembly 40 may be electrically connected to the lead tab 70.

The guide 210 according to embodiments of the present disclosure may move toward an upper side of the substrate tab bundle 60 to guide the substrate tab bundle 60.

As described with reference to FIG. 3, the electrode 10 may include the substrate 11 and the mixture layer 12. The substrate 11 may include an uncoated portion, which is a region in which the mixture layer 12 is not provided. The uncoated portion may extend in one side. Accordingly, the uncoated portion may extend outward from one side of the electrode assembly 40.

Here, the electrode assembly 40 may be formed by alternately stacking a plurality of first electrodes 101 and a plurality of second electrodes 102. Each of the plurality of electrodes 10 may include an uncoated portion extending from the electrode assembly 40. Accordingly, the secondary battery 100 may include the substrate tab bundle 60 formed by stacking a plurality of uncoated portions.

The guide 210 may move toward the substrate tab bundle 60 and guide the substrate tab bundle 60 so that the substrate tab bundle 60 is easily bent. For example, the guide 210 may move in a direction A toward the substrate tab bundle 60 from above the substrate tab bundle 60. The direction A may be, for example, a direction parallel to the Y-axis. However, unlike that shown in FIG. 5, the guide 210 may move toward the substrate tab bundle 60 from below the substrate tab bundle 60. Hereinafter, a case in which the guide 210 moves in the direction A will be described as an example.

The guide 210 may bring the plurality of uncoated portions into contact with one another by pressing the substrate tab bundle 60 downward from above. Accordingly, the guide 210 may form the substrate tab bundle 60, which is a bundle of the plurality of uncoated portions.

In addition, by pressing the substrate tab bundle 60, the guide 210 can fix the substrate tab bundle 60 while the substrate tab bundle 60 is bent in a subsequent process.

After the guide 210 presses the substrate tab bundle 60, the lead tab 70 may be connected to the substrate tab bundle 60. The lead tab 70 may be connected to the substrate tab bundle 60 through welding. For example, the welding may include ultrasonic welding, laser welding, PMW welding, and the like, but is not limited thereto. Alternatively, the lead tab 70 may be attached to the substrate tab bundle 60 by an electrical tape or the like, or may be physically coupled to the substrate tab bundle 60.

As shown in FIG. 5, the jig 220 according to embodiments of the present disclosure may be located above the lead tab 70. The jig 220 may move toward an upper side of the lead tab 70 and may support the upper side of the lead tab 70. For example, the jig 220 may move in a direction B toward the upper side of the lead tab 70 from above the lead tab 70. The direction B may be, for example, a direction parallel to the Y-axis.

Here, the jig 220 may press and support a connection portion at which the lead tab 70 and the substrate tab bundle 60 are connected to one another. Through this, the jig 220 may allow the substrate tab bundle 60 and the lead tab 70 to be firmly connected to one another. In addition, the jig 220 may fix the lead tab 70 relative to the substrate tab bundle 60.

Here, in order to easily press the connection portion, the jig 220 may be formed to have a shape extending in a direction parallel to the direction B. In addition, a surface of the jig 220 in contact with the connection portion may be formed as a flat surface. For example, the jig 220 may be formed substantially in a rod shape, a rectangular parallelepiped shape, a polygonal prism shape, and the like, but the shape of the jig 220 is not limited thereto.

As shown in FIG. 5, the pusher 230 according to embodiments of the present disclosure may be located below the lead tab 70 and the substrate tab bundle 60. For example, the pusher 230 may be located to correspond to the jig 220 with the substrate tab bundle 60 and the lead tab 70 interposed therebetween. The pusher 230 may move toward a lower side of the substrate tab bundle 60 and support the lower side of the substrate tab bundle 60. For example, the pusher 230 may move in a direction C toward the lower side of the substrate tab bundle 60 from below the substrate tab bundle 60. The direction C may be, for example, a direction parallel to the Y-axis. In addition, the direction C may be, for example, a direction opposite to the direction B.

Here, the pusher 230 may press and support the connection portion at which the lead tab 70 and the substrate tab bundle 60 are connected. Through this, the pusher 230 may allow the substrate tab bundle 60 and the lead tab 70 to be firmly connected to one another. In addition, the pusher 230 may fix the substrate tab bundle 60 relative to the lead tab 70 Here, in order to easily press the connection portion, the pusher 230 may be formed to have a shape extending in a direction parallel to the direction C. In addition, a surface of the pusher 230 in contact with the connection portion may be formed as a flat surface. For example, the pusher 230 may be formed substantially in a rod shape, a rectangular parallelepiped shape, a polygonal prism shape, and the like, but the shape of the pusher 230 is not limited thereto.

Accordingly, as shown in FIG. 5, the connection portion, at which the substrate tab bundle 60 and the lead tab 70 overlap and are connected, may be located between the pusher 230 and the jig 220. The connection portion may be pressed and fixed by the jig 220 and the pusher 230. Meanwhile, the positions of the jig 220 and the pusher 230 are provided merely for convenience of description, and embodiments of the present disclosure is not limited thereto. For example, the jig 220 may press the lower side of the substrate tab bundle 60, and the pusher 230 may press the upper side of the lead tab 70.

As shown in FIG. 5, one side of the lead tab 70 may be connected to the substrate tab bundle 60, and the other side of the lead tab 70 may extend outward therefrom.

As shown in FIG. 6, the roller 240 may perform primary bending of the lead tab 70. For example, the roller 240 may bend the lead tab 70 upward. For example, the roller 240 may cause the lead tab 70 to be bent toward the jig 220. The roller 240 may press the lead tab 70 on which primary bending has been performed. Meanwhile, the lead tab 70 may be pressed by the roller 240 while supported by the jig 220.

For example, the roller 240 may press the lead tab 70 while rotating. For example, the roller 240 may press the lead tab 70 while rotating clockwise. Alternatively, for example, the roller 240 may press the lead tab 70 while rotating counterclockwise. Alternatively, for example, the roller 240 may press the lead tab 70 while rotating clockwise and then press the lead tab 70 while rotating counterclockwise.

This is merely exemplary, and the roller 240 may press the lead tab 70 even by a method other than rotation. For example, the roller 240 may simply press the lead tab 70 to perform primary bending of the lead tab 70.

Meanwhile, the roller 240 may allow a bending angle at a point subjected to primary bending of the lead tab 70 to be about 90°. For example, the bending angle at the point subjected to primary bending may range from 85° to 95°. For example, the bending angle at the point subjected to primary bending may range from 80° to 100°. For example, when the bending angle at the point subjected to primary bending is about 90°, an extension line from one side of the lead tab 70 to the point subjected to primary bending and an extension line from the other side of the lead tab 70 to the point subjected to primary bending may be perpendicular to one another.

In this case, for example, the roller 240 may press the lead tab 70 at a pressure of 0.2 mPa or more and 0.6 mPa or less. Alternatively, for example, the roller 240 may press the lead tab 70 at a pressure of 0.3 mPa or more and 0.6 mPa or less. Alternatively, for example, the roller 240 may press the lead tab 70 at a pressure of 0.2 mPa or more and 0.5 mPa or less. Alternatively, for example, the roller 240 may press the lead tab 70 at a pressure of 0.3 mPa or more and 0.5 mPa or less.

When the roller 240 presses the lead tab 70 at a pressure of less than 0.2 mPa, the pressure applied to the lead tab 70 by the roller 240 may be insufficient, and thus the lead tab 70 may not be sufficiently softened. In addition, when the roller 240 presses the lead tab 70 at a pressure exceeding 0.6 mPa, the jig 220 may be pushed by the roller 240, and thus the electrode assembly 40 and/or the lead tab 70 itself may be damaged. Accordingly, the roller 240 may press the lead tab 70 at a pressure of 0.2 mPa or more and 0.6 mPa or less.

As shown in FIG. 7, when the primary bending of the lead tab 70 is completed, the jig 220 may cause the lead tab 70, on which the primary bending has been performed, to be straightened back. For example, the jig 220 may move away from the electrode assembly 40 in a direction D so that the lead tab 70, on which the primary bending has been performed, is straightened. Here, the direction D may be a direction parallel to the X-axis. The direction D may be a direction away from the electrode assembly 40. However, unlike that shown in FIG. 7, the jig 220 may move in a direction other than the direction D, and may move without straightening the lead tab 70. Even in this case, the lead tab 70, on which the primary bending has been performed, may be straightened to some extent as the jig 220 that supported the lead tab 70 and the roller 240 that pressed the lead tab 70 are removed.

As shown in FIG. 8, the roller 240 may perform secondary bending of the lead tab 70. For example, the roller 240 may cause the lead tab 70 to be bent downward. For example, the roller 240 may cause the lead tab 70 to be bent toward the pusher 230. The roller 240 may press the secondarily bent lead tab 70. Meanwhile, the lead tab 70 may be pressed by the roller 240 while supported by the pusher 230.

For example, the roller 240 may press the lead tab 70 while rotating. For example, the roller 240 may press the lead tab 70 while rotating clockwise. Alternatively, for example, the roller 240 may press the lead tab 70 while rotating counterclockwise. Alternatively, for example, the roller 240 may press the lead tab 70 while rotating clockwise and then press the lead tab 70 while rotating counterclockwise. Here, the primary bending and the secondary bending may be performed in different directions from one another. For example, when the primary bending is bending of the lead tab 70 counterclockwise, the secondary bending may be bending of the lead tab 70 clockwise. For example, when the primary bending is bending of the lead tab 70 upward, the secondary bending may be bending of the lead tab 70 downward.

This is merely exemplary, and the roller 240 may press the lead tab 70 even by a method other than rotation. For example, the roller 240 may simply press the lead tab 70 to perform secondary bending of the lead tab 70.

Meanwhile, the roller 240 may allow a bending angle at a point subjected to secondary bending of the lead tab 70 to be about 90°. For example, the bending angle at the point subjected to secondary bending may range from 85° to 95°. For example, the bending angle at the point subjected to secondary bending may range from 80° to 100°. For example, when the bending angle at the point subjected to secondary bending is about 90°, an extension line from one side of the lead tab 70 to the point subjected to secondary bending and an extension line from the other side of the lead tab 70 to the point subjected to secondary bending may be perpendicular to one another.

In this case, for example, the roller 240 may press the lead tab 70 at a pressure of 0.2 mPa or more and 0.6 mPa or less. Alternatively, for example, the roller 240 may press the lead tab 70 at a pressure of 0.3 mPa or more and 0.6 mPa or less. Alternatively, for example, the roller 240 may press the lead tab 70 at a pressure of 0.2 mPa or more and 0.5 mPa or less. Alternatively, for example, the roller 240 may press the lead tab 70 at a pressure of 0.3 mPa or more and 0.5 mPa or less.

When the roller 240 presses the lead tab 70 at a pressure of less than 0.2 mPa, the pressure applied to the lead tab 70 by the roller 240 may be insufficient, and thus the lead tab 70 may not be sufficiently softened. In addition, when the roller 240 presses the lead tab 70 at a pressure exceeding 0.6 mPa, the pusher 230 may be pushed by the roller 240, and thus the electrode assembly 40 and/or the lead tab 70 itself may be damaged. Accordingly, the roller 240 may press the lead tab 70 at a pressure of 0.2 mPa or more and 0.6 mPa or less.

As described herein, the roller 240 may perform the secondary bending of the lead tab 70, on which the primary bending has been performed, to form the bending region 701. When the bending region 701 is formed only by the primary bending, the bending region 701 may not be sufficiently softened. In this case, the bent portion 710 formed by bending the bending region 701 may have a bending angle exceeding 100°. In addition, when the bending angle exceeds 100°, an internal space of the case 50 may not be efficiently utilized.

On the other hand, when the bending region 701 is formed by the secondary bending, the bending region 701 may be sufficiently softened. Accordingly, the bent portion 710 formed by bending the bending region 701 may have a bending angle of 100° or less. When the bending angle is less than or equal to 100°, internal space efficiency of the case 50 may be increased.

Meanwhile, although not shown, the secondary battery manufacturing apparatus 200 may further include a sensor. The sensor may detect a position at which the bending region 701 is to be formed. The jig 220, the pusher 230, and/or the roller 240 may be located based on the position detected by the sensor and may bend the lead tab 70.

As described herein, the roller 240 bends a portion of the lead tab 70 electrically connected to the substrate tab bundle 60 extending from the electrode assembly 40, thereby forming the softened bending region 701.

As shown in FIG. 9, the pusher 230 bends the bending region 701. Through this, the pusher 230 may form the bent portion 710.

For example, the pusher 230 may move in a first direction F toward the lead tab 70 from below the lead tab 70 to bend the substrate tab bundle 60. For example, the first direction F may be a direction parallel to the Y-axis. While moving in the first direction F, the pusher 230 may push up the substrate tab bundle 60. Accordingly, the substrate tab bundle 60 may be bent.

In addition, for example, the pusher 230 may move in a second direction G toward the electrode assembly 40 to bend the bending region 701 and form the bent portion 710. For example, the second direction G may be a direction parallel to the X-axis. While moving in the second direction G, the pusher 230 may bend the bending region 701. Accordingly, the bent 33 portion 710 may be formed.

Here, for example, the guide 210 may move in a direction E so that the pusher 230 sufficiently pushes up the substrate tab bundle 60 and the bending region 701 can be sufficiently bent. The direction E may be a direction in which the guide 210 moves away from the substrate tab bundle 60. For example, the direction E may be parallel to the Y-axis, but is not limited thereto.

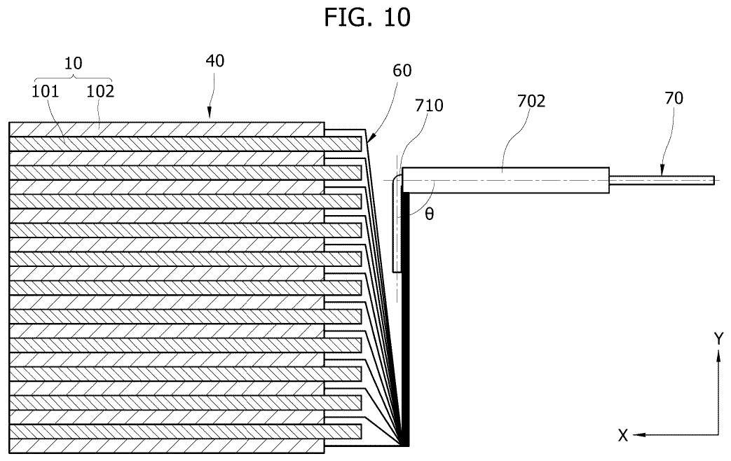

FIG. 10 is a view illustrating a secondary battery manufactured by the secondary battery manufacturing apparatus according to embodiments of the present disclosure.

The secondary battery 100 according to embodiments of the present disclosure (for example, including the secondary battery 100 described with reference to FIGS. 1 to 9) may include an electrode assembly 40 from which a substrate tab bundle 60 extends, a case 50 accommodating the electrode assembly 40, and a lead tab 70 of which one side is electrically connected to the substrate tab bundle 60 and the other side is led out to the outside of a case 50. Here, the lead tab 70 includes a bent portion 710 formed by bending a softened bending region. In FIGS. 10, θ represents a bending angle of the bent portion of the lead tab. The bending angle θ represents an intersection angle between an extension line from one side of the lead tab to the bent portion and an extension line from the other side of the lead tab (for example, a point where sealing of the lead tab begins) to the bent portion.

The lead tab 70 may include a first region and the bent portion 710 and include a second region formed to have a smaller thickness than the first region. The first region denotes all regions except the second region. The second region denotes a region in which the bent portion 710 is formed. The second region denotes all regions softened in the lead tab 70. As the second region is softened by pressing, the second region may be formed to have a smaller thickness than the first region.

The bent portion 710 may have a bending angle θ of less than or equal to 100°. For example, the bending angle θ may be less than 98°. For example, the bending angle θ may be less than 96°. For example, the bending angle θ may be less than 94°. For example, the bending angle θ may be less than 92°. For example, the bending angle θ may be less than 90°. Alternatively, for example, the bending angle θ may be an acute angle.

The bent portion 710 may be located in the case 50. As described herein, as the bent portion 710 is formed inside the case 50 with a small bending angle θ, internal space efficiency of the case 50 may be improved.

Meanwhile, the secondary battery 100 may further include an insulating member 702.

For example, the insulating member 702 may include an insulating material. For example, the insulating material may include at least one selected from the group consisting of PA6, polyimide (PI), polysulfone, polyurethane (PU), polyamide (PA), nylon 6,6, polycarbonate (PC), polytetrafluoroethylene (PTFE), polymethyl methacrylate (PMMA), and polyethylene terephthalate (PET).

The insulating member 702 may surround the lead tab 70 and may be located between the lead tab 70 and the case 50. The insulating member 702 may prevent the occurrence of a short circuit between the case 50 and the lead tab 70. The insulating member 702 may further seal a space between the lead tab 70 and the case 50 so that the case 50 is sealed.

The bent portion 710 may be located so as not to overlap the insulating member 702. When the bent portion 710 is located to overlap the insulating member 702, the bent portion 710 may not be sufficiently bent due to the insulating member 702. In this case, the bending angle θ may be formed to be greater than or equal to 100°. Accordingly, the bent portion 710 may be formed so as not to overlap the insulating member 702.

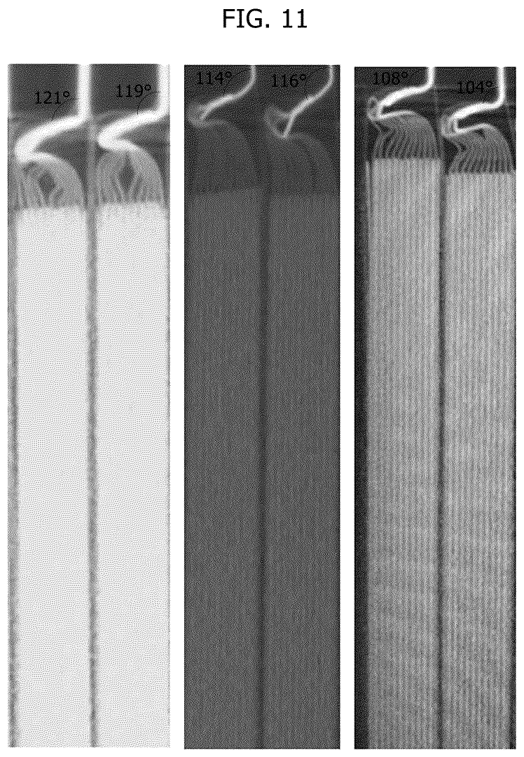

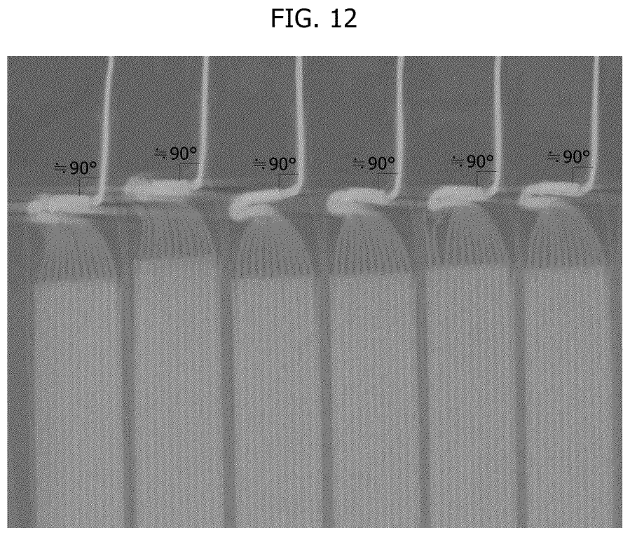

FIG. 11 is a photograph illustrating a conventional secondary battery. FIG. 12 is a photograph illustrating a secondary battery according to embodiments of the present disclosure. As shown in FIG. 11, the conventional secondary battery includes a lead tab in which a bending region is not softened. Accordingly, it can be seen that, due to the rigidity of the lead tab, the lead tab of the conventional secondary battery is not sufficiently bent. It can be seen that the conventional secondary battery includes the lead tab in which a bending angle of a bent portion is greater than or equal to 100°.

In contrast, as shown in FIG. 12, the secondary battery 100 according to embodiments of the present disclosure includes the lead tab 70 in which the bending region is softened. Accordingly, it can be seen that the lead tab 70 of the secondary battery 100 is sufficiently bent. It can be seen that the secondary battery 100 includes the lead tab 70 in which the bending angle of the bent portion 710 is less than or equal to 100°.

According to the present disclosure, a secondary battery having increased internal space efficiency of a case can be manufactured and provided.

According to the present disclosure, a secondary battery having improved safety can be manufactured and provided.

However, it will be appreciated by those skilled in the art that the effects that can be achieved through the present disclosure are not limited to what has been described hereinabove and other advantages of the present disclosure will be more clearly understood from the herein detailed description.

Although the present disclosure has been described with reference to the limited embodiments and drawings, the present disclosure is not limited thereto and may be variously implemented by those of ordinary skill in the art to which the present disclosure pertains, within the technical idea of the present disclosure and an equivalent of the appended claims.

What is claimed is:

1. A secondary battery manufacturing apparatus comprising:
a roller configured to bend a portion of a lead tab electrically connected to a substrate tab bundle extending from an electrode assembly to form a softened bending region; and
a pusher configured to bend the bending region.

2. The secondary battery manufacturing apparatus of claim 1, further comprising a jig configured to move toward an upper side of the lead tab and support the lead tab at the upper side, wherein the roller performs primary bending of the lead tab along the jig.

3. The secondary battery manufacturing apparatus of claim 2, wherein:
the pusher moves toward a lower side of the lead tab to support the lead tab at the lower side, and
the roller performs secondary bending of the lead tab, on which the primary bending has been performed, along the pusher to form the bending region.

4. The secondary battery manufacturing apparatus of claim 3, wherein the primary bending and the secondary bending are performed in different directions from one another.

5. The secondary battery manufacturing apparatus of claim 3, wherein the pusher moves in a first direction toward the lead tab from the lower side of the lead tab to bend the substrate tab bundle.

6. The secondary battery manufacturing apparatus of claim 5, wherein the pusher moves in a second direction toward the electrode assembly and bends the bending region to form a bent portion.

7. The secondary battery manufacturing apparatus of claim 1, further comprising a guide configured to move toward an upper side of the substrate tab bundle and guide the substrate tab bundle.

8. The secondary battery manufacturing apparatus of claim 1, wherein the roller presses the lead tab at a pressure of 0.2 mPa or more and 0.6 mPa or less to form the bending region.

9. The secondary battery manufacturing apparatus of claim 1, further comprising a sensor configured to detect a position of the bending region.

10. The secondary battery manufacturing apparatus of claim 1, wherein the pusher bends the bending region so that the lead tab is bent at an angle of 100° or less.

11. A secondary battery manufacturing method comprising:
bending a portion of a lead tab electrically connected to a substrate tab bundle extending from an electrode assembly to form a softened bending region; and
bending the bending region.

12. The secondary battery manufacturing method of claim 11, further comprising:
supporting, by a jig, the lead tab at an upper side thereof; and
performing primary bending of the lead tab.

13. The secondary battery manufacturing method of claim 12, further comprising:
supporting, by a pusher, the lead tab at a lower side thereof; and
performing secondary bending of the lead tab, on which the primary bending has been performed, to form the bending region,
wherein the primary bending and the secondary bending are performed in different directions from one another.

14. The secondary battery manufacturing method of claim 13, further comprising:
moving the pusher in a first direction toward the lead tab from the lower side of the lead tab to bend the substrate tab bundle; and
moving the pusher in a second direction toward the electrode assembly and bending the bending region to form a bent portion.

15. The secondary battery manufacturing method of claim 14, wherein the pusher causes the bent portion to be bent at an angle of 100° or less.

16. A secondary battery comprising:
an electrode assembly from which a substrate tab bundle extends;
a case accommodating the electrode assembly; and
a lead tab of which one side is electrically connected to the substrate tab bundle and another side is led out of the case,
wherein the lead tab includes a bent portion formed by bending a softened bending region.

17. The secondary battery of claim 16, wherein the lead tab includes:
a first region; and
a second region including the bent portion and formed to have a smaller thickness than a thickness of the first region.

18. The secondary battery of claim 16, wherein the bent portion is bent at an angle of less than or equal to 100°.

19. The secondary battery of claim 16, wherein the bent portion is located inside the case.

20. The secondary battery of claim 16, further comprising an insulating member surrounding the lead tab and located between the lead tab and the case, wherein the bent portion is located so as not to overlap the insulating member.
